(19) United States
(12) Patent Application Publication
(10) Pub. No.: US 2016/0247140 A1
(43) Pub. Date: Aug. 25, 2016

(54) SYSTEM AND METHOD FOR LOCATING A MOBILE SUBSCRIBER TERMINAL WHEN ROAMING

(71) Applicant: ZUMIGO, INC., San Jose, CA (US)

(72) Inventor: Chirag C. BAKSHI, San Jose, CA (US)

(21) Appl. No.: 15/044,922

(22) Filed: Feb. 16, 2016

Related U.S. Application Data
(62) Division of application No. 13/493,923, filed on Jun. 11, 2012, now abandoned.
Application No. 13/493,923 is a continuation-in-part of application No. 13/016,368, filed on Jan. 28, 2011, now abandoned.

(51) Int. Cl. G06Q 20/32; G06Q 20/20; H04W 12/06; H04L 29/06; H04W 12/08

(52) U.S. Cl. CPC G06Q 20/3224; H04L 63/107; H04W 12/08; H04W 12/06; G06Q 20/202

(57) ABSTRACT

The location of a mobile subscriber roaming outside a home network may be used to authorize a transaction initiated by the mobile subscriber or to authenticate the mobile subscriber when signing into secure accounts. The location of the mobile subscriber is determined by providing a unique mobile subscriber identifier, such as the MSISDN, to an application that communicates with the home network and the roaming network. By communicating with the roaming network, the application can determine the current location of the roaming mobile subscriber terminal with location resolution down to the specific cell in which the mobile subscriber terminal is located. The location of the mobile subscriber terminal may be saved locally in a database associated with an authorization entity, thereby advantageously reducing the number of location look-ups requested by the authorization entity.

### CROSS-REFERENCE TO RELATED APPLICATION(S)

This application is a divisional of U.S. patent application Ser. No. 13/493,923, filed Jun. 11, 2012, which is a continuation-in-part of U.S. patent application Ser. No. 13/016,368, filed Jan. 28, 2011, the entire contents of which are incorporated by reference herein.

### BACKGROUND OF THE INVENTION

1. Field of the Invention

Embodiments of the present invention generally relate to wireless telecommunication systems and, more specifically, to systems and methods for locating a mobile subscriber terminal when roaming.

2. Description of the Related Art

It has become common practice for individual consumers to use telecommunications systems for conducting financial and other transactions. Specifically, wireless communication devices and/or the Internet are frequently used for point-of-sale (POS) and on-line transactions, such as banking, purchasing, and other financial transactions. Consequently, the development of robust security and authentication procedures for such transactions is becoming increasingly important, particularly when the individual making the transactions is traveling in a foreign country.

Further, with the modern ubiquity of foreign travel, the ability to remotely and reliably locate an individual, in either a commercial or personal context, is frequently desirable. Current techniques for determining the physical location of an individual who is traveling involve obtaining the location of a mobile subscriber terminal, e.g., a cell phone, smart phone, or other wireless telecommunication device, by issuing a request to the operational support system of the individual's wireless communication service provider. For example, the Home Location Register (HLR) of a service provider can identify the Mobile Switching Center (MSC) that is serving a particular mobile subscriber terminal and thereby determine an approximate geographical location of the mobile subscriber terminal. However, such an approach for locating a user assumes that the user of the mobile subscriber terminal is in-network and consequently the approach does not work when the user travels out-of-network, e.g., to a foreign country.

Accordingly, there is also a need in the art for reliably and remotely locating a user of a mobile subscriber terminal when the user roams out of the home service network.

### SUMMARY OF THE INVENTION

One or more embodiments of the invention provide techniques for locating a mobile subscriber when the mobile subscriber roams out of his or her home network. According to these techniques, a data structure mapping Mobile Switching Centers (MSCs) to the physical location of the MSCs is accessed and this mapping is used to locate a mobile subscriber when the mobile subscriber roams out of his or her home network and registers with one of these MSCs. An authentication entity may use the location of the mobile subscriber to authorize a transaction initiated by the mobile subscriber or to authenticate the mobile subscriber when signing into secure accounts. In some embodiments, the mobile subscriber location is saved locally in a database that is associated with the authorization entity to reduce the number of location look-ups performed.

A method of authorizing a transaction, according to an embodiment, includes the steps of receiving a request to authorize a transaction being conducted at a point-of-sale (POS), acquiring purchaser data from the request, transmitting a request to locate the purchaser and receiving location data indicating a location of the purchaser in response thereto, storing the purchaser location, comparing a POS location with the purchaser location, and authorizing or denying the transaction based on the step of comparing. A request to authorize a transaction being conducted at a different POS may be authorized or denied based on a comparison of a location of the different location with the stored purchaser location.

A method of authenticating a user for access to a secure account, according to an embodiment, includes the steps of receiving a request to access the secure account from an IP address associated with the user, transmitting a request to locate the user and receiving location data indicating a location of the user in response thereto, storing the user location, comparing a location associated with the IP address with the location of the user, and authorizing or denying the access based on the step of comparing. A request to access the secure account from a different IP address may be authorized or denied based on a comparison of a location of the different IP address with the stored user location.

A method of locating a user of a wireless communication device who has roamed out of network, according to an embodiment, includes the steps of receiving an identifier of a mobile switching center (MSC ID) that is serving the user out of network, transmitting a request for user location data to the mobile switching center, the request including an identifier of the wireless communication device, and determining a location of the user based on the user location data received from the mobile switching center. The user location data includes an identifier of a cell (cell ID) within the mobile switching center, and the location of the user is determined based on the cell ID, e.g., by accessing a data structure that maps cell IDs to physical locations of the cells.

Further embodiments of the invention include a non-transitory computer-readable storage medium that includes instructions that enable a processing unit to implement one or more of the methods set forth above, and a computer system that is configured to carry out one or more of the methods set forth above.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a conceptual diagram illustrating a system that enables location tracking of a mobile subscriber terminal, according to an embodiment of the present invention.

FIG. 2 schematically illustrates the contents of a location mapping database, according to an embodiment of the invention.

FIG. 3 is a conceptual diagram illustrating a system that enables location tracking of a mobile subscriber terminal roaming mode outside a home network, according to an embodiment of the present invention.

FIG. 4 schematically illustrates the contents of a mapping database, according to an embodiment of the invention.

FIG. 5 is a block diagram of a transaction processing system illustrating the steps of a financial transaction that are carried out according to an embodiment of the present invention.

FIG. 6 is a flow chart that summarizes, in a stepwise fashion, a method for authorizing transactions based on location information acquired by a location provider, according to an embodiment of the invention.

FIG. 7 is a schematic diagram comparing the functionality of three different embodiments of the invention for authenticating user/purchaser location based on location information acquired by a location provider module.

FIG. 8 is a flow chart that summarizes, in a stepwise fashion, a method for authenticating a user for access to a secure account based on location information acquired by a location provider, according to an embodiment of the invention.

FIG. 9 is a block diagram of a transaction processing system illustrating the steps of a financial transaction that are carried out according to an embodiment of the present invention.

FIG. 10 is a flow chart that summarizes, in a stepwise fashion, a method for storing and using location information for a mobile subscriber in a database that is associated with an authorization entity, according to an embodiment of the invention.

FIG. 11 is a conceptual diagram illustrating a system that outputs the current location of a roaming mobile subscriber terminal when the system is queried with a unique mobile subscriber identifier, according to embodiments of the invention.

FIG. 12 is a flow chart that summarizes, in a stepwise fashion, a method for determining the location of a mobile subscriber terminal, according to an embodiment of the invention.

For clarity, identical reference numbers have been used, where applicable, to designate identical elements that are common between figures. It is contemplated that features of one embodiment may be incorporated in other embodiments without further recitation.

### DETAILED DESCRIPTION

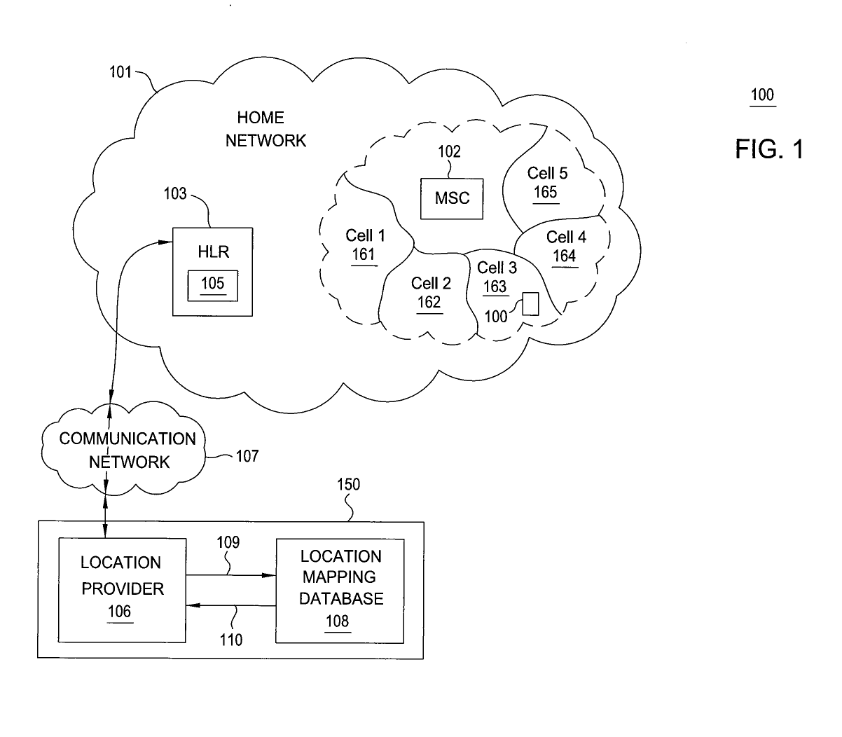

FIG. 1 is a conceptual diagram illustrating a system 150 that enables location tracking of a mobile subscriber terminal 100, according to an embodiment of the present invention. Mobile subscriber terminal 100 may be any type of wireless communication device, such as a cell phone, a smart phone, etc. As shown, mobile subscriber terminal 100, and presumably also the user of mobile subscriber terminal 100, is located in the primary serving network serving mobile subscriber terminal 100. The primary serving network of mobile subscriber terminal 100 is herein referred to as home network 101, and the user of mobile subscriber terminal 100 is referred to herein as a mobile subscriber.

Home network 101 is a wireless communication system that includes at least one Mobile Switching Center (MSC) 102, a Home Location Register (HLR) 103, and a plurality of cell towers 161-165. MSC 102 connects the landline public switched telephone network system to home network 101. Home network 101 may be a small network and only include a single MSC 102. Alternatively, home network 101 may be a relatively large network, i.e., a network that services a large geographical area, and may include multiple MSCs 102. For clarity, only a single MSC 102 is depicted in FIG. 1. Each MSC 102 in home network 101 has a plurality of cell towers 161-165 associated therewith, where each of cell towers 161-165 serves a specific geographical area, i.e., cells 1-5, respectively. HLR 103 of home network 101 contains geographical information regarding mobile subscriber terminal 100, where such geographical information may be a place name, a latitude-longitude coordinate or a combination of both. Specifically, HLR 103 contains a data structure 105 that identifies the particular MSC 102 currently serving mobile subscriber terminal 100 and the closest cell tower to mobile subscriber terminal 100. Information contained in data structure 105 includes a mobile subscriber identification number, MSC identification number (MSCID), cell tower number, mobile subscriber terminal serial number, an indicator telling the mobile subscriber terminal is in the home network, etc.

System 150 includes a location provider 106 and a location mapping database 108. Location provider 106 is a logical module, program, or algorithm that determines the location of mobile subscriber terminal 100 by querying location mapping database 108. Location mapping database 108 is a data structure that maps each MSC 102 in home network 101 to a specific geographical location. In some embodiments, location mapping database 108 also maps each of cell towers 161-165 to a specific geographical location. In some embodiments, system 150 may be an integral part of the Operational Support System (OSS) of the cellular service provider. Consequently, location provider 106 and location mapping database 108 may be constructed, maintained, and populated by the operator of home network 101. In other embodiments, system 150 may be a separate entity from home network 101 and therefore may be constructed, maintained, and populated by a third party.

Communication between home network 101 and system 150 is carried out via communication network 107. In some embodiments, communication network 107 may comprise the Internet, the Signaling System 7 (SS7) network, the Public Switched Telephone Network (PSTN) or a combination thereof. The SS7 network is used for communicating control, status, and signaling information between nodes in a telecommunication network.

In operation, when mobile subscriber terminal 100 physically enters the geographical region served by home network 101, mobile subscriber terminal 100 registers with home network 101 and MSC 102 captures the identity of the specific cell tower of cell towers 161-165 that is closest to mobile subscriber terminal 100. This registration process enables mobile subscriber terminal 100 to be alerted to an incoming phone-call or message. Calls are completed and messages delivered via this closest cell tower.

As mobile subscriber terminal 100 changes location in home network 101, the identity of the closest cell tower is maintained by MSC 102. Location provider 106 periodically queries HLR 103 via communication network 107 in order to track the current MSC and/or cell tower that is closest to mobile subscriber terminal 100. In some embodiments, the cell phone number associated with mobile subscriber terminal 100 is used to identify mobile subscriber terminal 100. In other embodiments, location provider 106 uses a serialized equipment number associated with mobile subscriber terminal 100 to identify mobile subscriber terminal 100. If the mobile registry is null, i.e., mobile subscriber terminal 100 is not currently registered in home network 101, then a “not-in-network” message is returned to location provider 106 by HLR 103.

After location provider 106 receives a reply from HLR 103 that identifies the closest MSC and/or cell tower to mobile subscriber terminal 100, location provider 106 queries location mapping database 108 via query 109. Query 109 includes the MSCID of said MSC and/or the appropriate cell tower number. Location mapping database 108 then returns the geographical location of MSC 102 to location provider 106 via reply 110. In some embodiments, the granularity of position of mobile subscription terminal 100 is enhanced by also providing cell tower location in reply 110. In other embodiments, inclusion of the geographical location of MSC 102 in reply 110 is sufficient. Thus, location provider 106 is continuously updated with the current geographical location of mobile subscriber terminal 100 and, presumably, the mobile subscriber, and consequently can provide such location information to any authorized party, e.g., employer, spouse, bank, on-line merchant, etc.

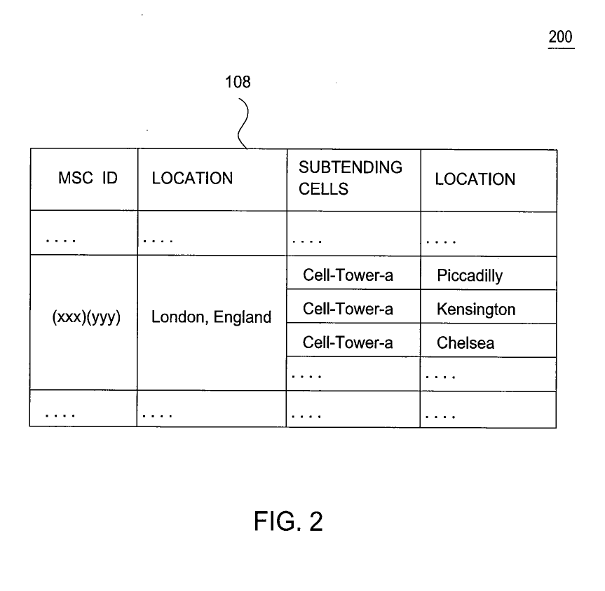

FIG. 2 schematically illustrates the contents of location mapping database 108, according to an embodiment of the invention. As shown, location mapping database 108 provides mappings of MSCs to the physical location of the area served by each MSC. In some embodiments, location mapping database 108 also includes the geographical locations corresponding to each subtending cell tower of each MSC included in mapping database 108.

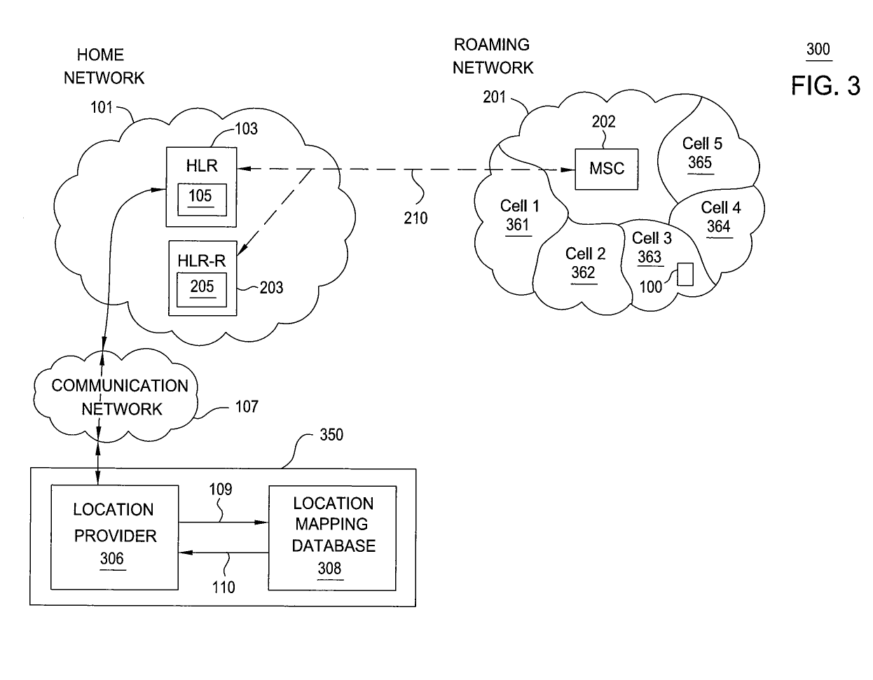

FIG. 3 is a conceptual diagram illustrating a system 350 that enables location tracking of a mobile subscriber terminal 100 roaming mode outside home network 101, according to an embodiment of the present invention. As shown, mobile subscriber terminal 100, and presumably also the mobile subscriber, is roaming outside home network 101 and is physically located in a roaming network 201, such as a cell phone network in a foreign country.

Roaming network 201 is substantially similar in organization and operation to home network 101, and includes one or more MSCs 202, each with its attendant cell towers 361-365. In addition to HLR 103, home network 101 includes a remote HLR, herein referred to as HLR-R 203. HLR-R 203 contains information regarding the MSC 202 in roaming network 2011 in which mobile subscriber terminal 100 has registered.

Similar to HLR 103, HLR-R 203 contains geographical information regarding mobile subscriber terminal 100. In contrast to HLR 103, HLR-R 203 contains a data structure 205 that identifies the particular MSC 202 in roaming network 201 that is currently serving mobile subscriber terminal 100. Information contained in data structure 205 includes a mobile subscriber identification number, MSC identification number, mobile subscriber terminal serial number, etc. In some embodiments, data structure 205 may also include the cell tower number of the closest cell tower to mobile subscriber terminal 100.

System 350 is substantially similar in organization and operation to system 150 in FIG. 1. One difference between system 350 and system 150 is that system 350 includes a location mapping database 308, analogous to mapping database 108, that maps each MSC 202 in one or more roaming networks, e.g., roaming network 201, to a specific geographical location. In some embodiments, location mapping database 308 also maps each of cell towers 361-365 to a specific geographical location. In some embodiments the database 308 also maintains a record of the last location mapped for the mobile subscriber terminal.

When mobile subscriber terminal 100 is outside home network 101, roaming network 201 accepts registry of mobile subscriber terminal 100, assuming there is a roaming agreement between the operator of home network 101 and the operator of roaming network 201. As part of normal operation of home network 101 and roaming network 201, the identity of mobile subscriber terminal 100 is communicated over a telephony signaling network 210 to home network 101, together with the appropriate MSC identification for MSC 202 for inclusion in data structure 205, where MSC 202 is the MSC currently serving mobile subscriber terminal 100. Such information that is communicated from roaming network 201 to home network 101 may be maintained in roaming network 201 in a database equivalent to data structure 105 in HLR 103 for mobile subscriber terminals from other networks, i.e., mobile subscriber terminals roaming in roaming network 201. This database containing information related to roaming subscriber units is called the Visitor Location Registry (VLR).

In operation, location provider 306 queries home network 101 regarding the location of mobile subscriber terminal 100. When HLR 103 is queried by location provider 306, mobile subscriber terminal 100 is discovered to be roaming. Location provider 306 then queries HLR-R 203, and receives the MSC ID of MSC 202, which is the MSC currently serving mobile subscriber terminal 100 in roaming network 201. The geographical location of mobile subscriber terminal 100 is then obtained from location mapping database 308 in the same way that system 150 obtains geographical location for mobile subscriber terminal 100 from location mapping database 108. Thus, location provider 306 is continuously updated with the current geographical location of mobile subscriber terminal 100, even when mobile subscriber terminal 100 is located in a foreign country or otherwise roaming outside home network 101. Consequently, location provider 306 can readily provide location information for mobile subscriber terminal 100 to any authorized party, e.g., employer, spouse, bank, on-line merchant, etc.

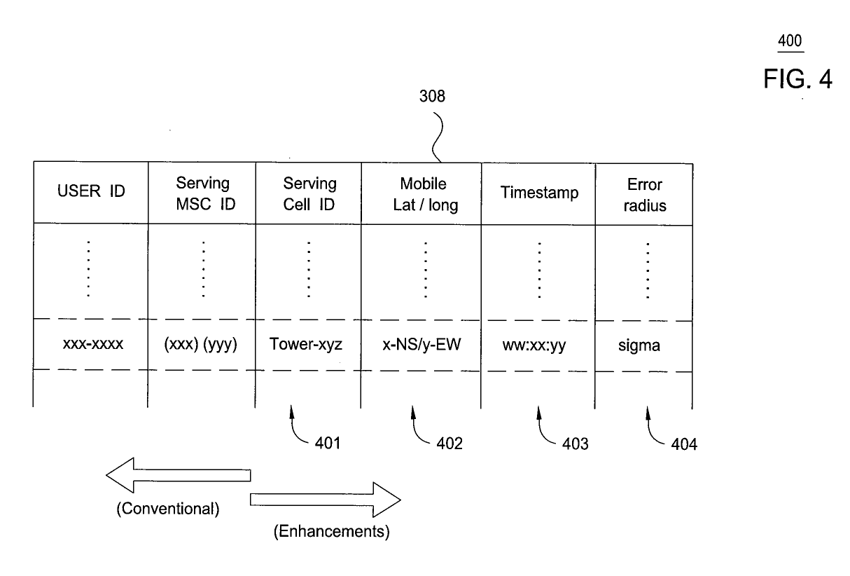

FIG. 4 schematically illustrates the contents of mapping database 308, according to an embodiment of the invention. Location mapping database 308 is substantially similar in organization to mapping database 108, except that, at a minimum, location mapping database 308 provides mappings of roaming MSCs to the physical location of the area served by all included roaming MSCs. Specifically, the roaming MSCs are selected from one or more roaming networks, e.g., roaming network 201, and not home network 101. Other elements of location mapping database 308 that are enhancements over prior art location mapping databases may include serving cell tower ID 401, latitude/longitude coordinate 402, timestamp 403, and error radius 404. The information contained in location mapping database 308 may be generated and maintained by home network 101 by surveying roaming network operators on an on-demand or on a scheduled basis.

In some embodiments, location mapping database 308 maps mobile subscriber terminal 100 to the physical location of a serving MSC in roaming network 201, e.g., MSC 202. Granularity of the position of mobile subscriber terminal 100 may be increased when location mapping data base 308 includes serving cell tower ID 401 and/or latitude/longitude coordinate 402 in roaming network 201, thereby mapping to the closest cell-tower and/or latitude/longitude coordinate. Latitude/longitude coordinate 402 may correspond to a fixed cell tower or MSC location, or may be a triangulated position between cell towers 361-365 that is determined by roaming network 201, or may be a GPS (Global Positioning Satellite) coordinate received directly from mobile subscriber terminal 100. Time-stamp 403 serves to indicate when the location entries were made to mapping database 308, and error radius 404 serves to quantify the granularity of the location estimate for mobile subscriber terminal 100.

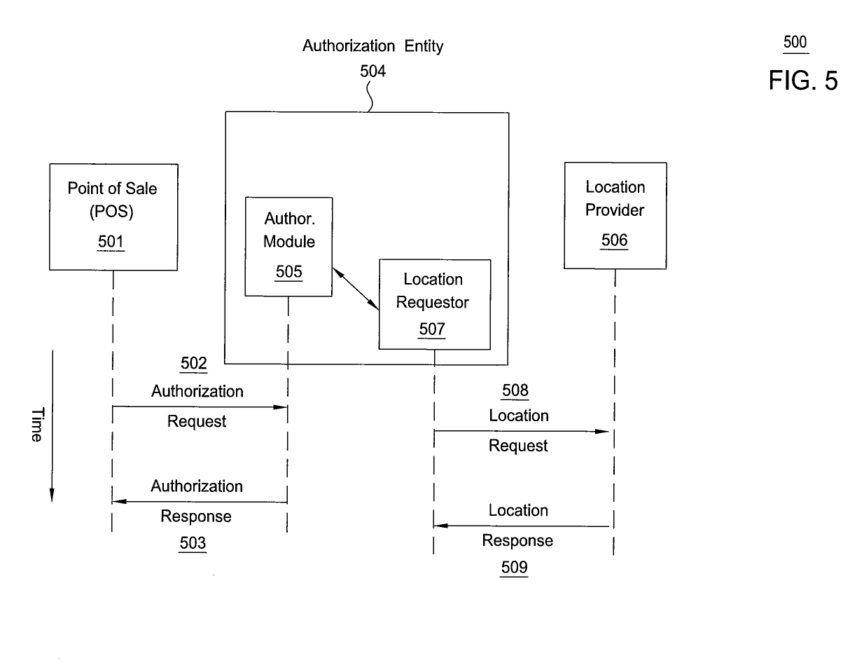

FIG. 5 is a block diagram of a transaction processing system 500 illustrating the steps of a financial transaction that are carried out according to an embodiment of the present invention. As part of the financial transaction illustrated in FIG. 5, a transaction is authorized based on location information acquired using system 150 or system 350, according to embodiments of the invention. In an exemplary transaction, when a credit card is presented at a point-of-sale (POS) merchant, herein referred to as POS 501, POS 501 submits an authorization request 502 to an authorization entity 504, e.g., the issuing entity of the credit-card. POS 501 accepts the credit card as form of payment for the purchase only when the transaction is authorized by authorization entity 504, i.e., only after receiving authorization response 503 from authorization entity 504. According to the embodiment of the present invention illustrated in FIG. 5, prior to sending authorization response 503 to POS 501, an authorization module 505 of authorization entity 504 confirms the location of the credit card holder by querying a location provider 506 for the current location of the credit card holder. Location provider 506 is substantially similar in organization and operation to either location provider 106 of system 150 or location provider 306 of system 350. Location requester 507 of authorization entity 504 sends location request 508 to location provider 506 and awaits location response 509. If the credit card holder's current location, as determined by location provider 506 and included in location response 509, does not match the physical location of POS 501, the authorization request is denied. If the credit card holder's current location matches the physical location of POS 501, then the authorization may be further based on other parameters such as credit limit, etc., available in security database 520.

In the embodiment illustrated in FIG. 5, a purchase using a credit-card at a POS is depicted. In other embodiments, other types of transactions are within the scope of the present invention, such as on-line transactions. In the case of certain on-line transactions, authorization of a transaction can be contingent on the location of the computer being used to initiate the on-line transaction. The location of said computer is extracted from the computer IP address and compared to the location of the mobile subscriber's mobile subscriber terminal 100 as provided by location provider 506.

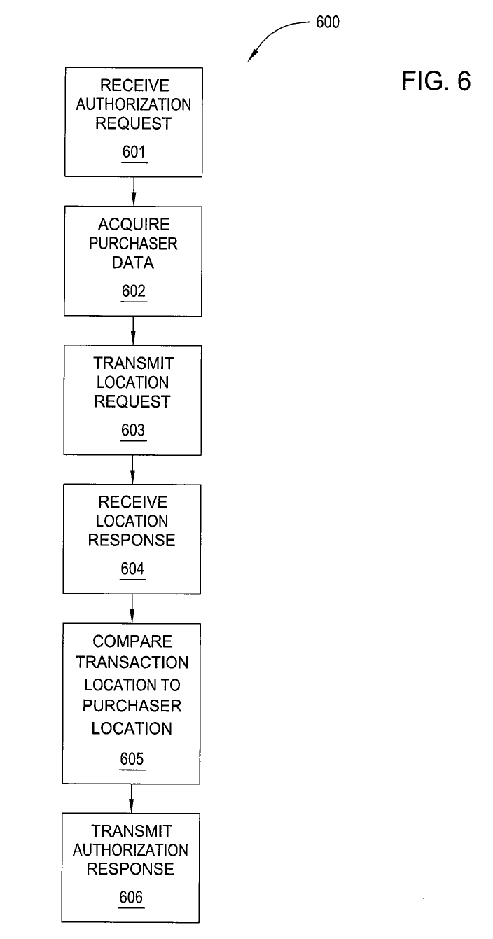

FIG. 6 is a flow chart that summarizes, in a stepwise fashion, a method 600 for authorizing transactions based on location information acquired by a location provider, according to an embodiment of the invention. By way of illustration, method 600 is described in terms of a transaction processing system substantially similar in organization and operation to transaction processing system 500 in FIG. 5. However, other transaction processing systems may also benefit from the use of method 600. Although the method steps are described in conjunction with FIG. 6, persons skilled in the art will understand that any system configured to perform the method steps falls within the scope of the present invention.

Prior to method 600, a purchaser, who is also the user of mobile subscriber terminal 100, initiates a transaction, such as a credit card purchase, at POS 501. POS 501 queries the authorization entity 504 by transmitting authorization request 502 to authorization entity 504 to confirm allowance of the transaction. Authorization request 502 will include an identification of the subscriber, e.g. the mobile subscriber name, phone number, and/or the Mobile Subscriber ISDN Number (MSISDN). The physical location of POS 501 is either communicated explicitly in request 502, indirectly by caller ID if authorization request 502 is communicated by modem over a telephone network, or indirectly by IP address if authorization request 502 is communicated over the Internet. In one embodiment, the request includes a time-stamp of authorization request 502.

The method begins in step 601, in which authorization entity 504 receives authorization request 502. As noted above, authorization request 502 includes the physical location of the transaction taking place. In the case of an on-line transaction, the physical location for the transaction corresponds to a physical location of the IP address associated with the purchaser.

In step 602, authorization entity 504 acquires purchaser data from authorization request 502, such as purchaser identification data and physical location data for the transaction.

In step 603, authorization entity 504 transmits location request 508 to location provider 506.

In step 604, authorization entity 504 receives location response 509 from location provider 506. Location response 509 includes location data indicating the current physical location of the purchaser based on the location of mobile subscriber terminal 100.

In step 605, authorization entity 504 compares the physical location of the transaction as acquired in step 602 to the physical location of the purchaser reported by location provider 506 in step 604. In some cases, obtaining the physical location of the transaction may require an additional step. For example, if the transaction is being made with a merchant that has a chain of stores at different physical locations, techniques described in U.S. patent application Ser. No. 11/994,977, which is incorporated by reference herein in its entirety, may be used to obtain the physical location of the transaction.

In step 606, authorization entity 504 transmits an appropriate authorization response 503 to POS 501 based on the results of step 605. For example, the response from authorization entity 504 is “accepted” (or “authorized,” “allowed,” etc.) and the transaction can proceed if the two locations compared in step 605 are found to be within a predetermined minimum radius, e.g., 100 miles. This predetermined minimum radius is dependent on the geographical location being considered and the serving radius of an MSC. In sparsely populated areas, the serving radius of an MSC can be on the order of 100 miles and the predetermined minimum radius is adjusted accordingly. On the other hand, in densely populated areas, the serving radius of an MSC is much less than 100 miles, on the order of 5 miles or so, and the predetermined minimum radius is adjusted accordingly. The response from authorization entity 504 is “denied” if the two locations compared in step 605 are found to be separated by more than the predetermined minimum radius. In the latter case, the merchant may take the appropriate action such as notifying the authorities in the case of fraud. In an alternative embodiment, authorization entity 504 may over-ride the decision based on behavioral patterns of the purchaser and/or behavioral patterns of the merchant. For example, if the purchaser is a frequent traveler, authorization entity 504 may authorize the transaction even if the distance between the two locations compared in step 605 exceeds the predetermined minimum radius. In some embodiments, if authorization entity 504 has not been informed of the nature of the travel by the purchaser, authorization of the transaction may be withheld even if the distance between the two locations compared in step 605 is within the predetermined minimum radius.

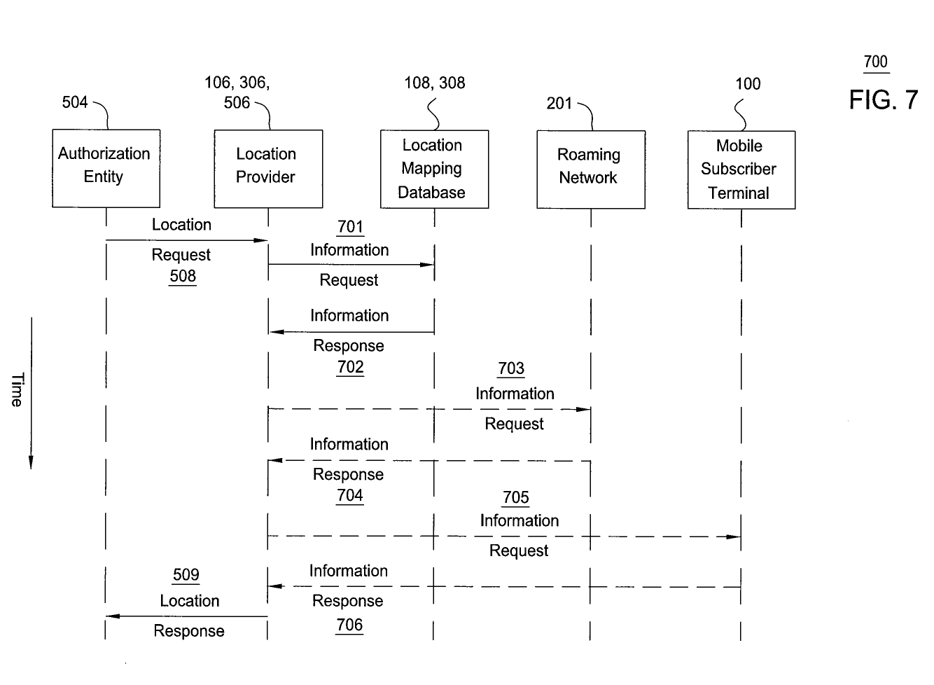

FIG. 7 is a schematic diagram comparing the functionality of three different embodiments of the invention for authenticating mobile subscriber/purchaser location based on location information acquired by a location provider module, such as location provider 106, 306, or 506. In each embodiment, the mobile subscriber is a purchaser or other initiator of a transaction.

In a first embodiment, a location provider, e.g., 106, 306 or 506, retrieves the MSC ID from home network 101 and then issues an information request 701. From an information response 702, the location of the MSC serving mobile subscriber terminal 100 is obtained from a location mapping database 108, 308. If the mobile subscriber/purchaser is in home network 101, then additional granularity in the form of cell-tower identifiers may be available. If the subscriber is roaming, then the response may only have the MSC ID of the MSC in roaming network 201 that is serving mobile subscriber terminal 100.

In a second embodiment, the mobile subscriber is roaming when initiating a transaction. The location provider, e.g., location provider 306 or 506, retrieves the MSC ID from home network 101 and thereby identifies the roaming network 201. The location of the mobile subscriber terminal 100 is obtained from roaming network 201 by issuing an information request 703 to the provider of roaming network 201. Information request 703 may be made over the Internet or over the SS7 network. An information response 704 will include additional granularity of geographical location of mobile subscriber terminal 100 in the form of serving cell tower numbers associated with the serving MSC in roaming network 201. Such geographical information can be written to the appropriate location mapping database, e.g., location mapping database 108 or 308.

In a third embodiment, mobile subscriber terminal 100 has an embedded application and GPS location capability. A location provider issues a location information request 705 directly to mobile subscriber terminal 100 using the Internet or the Short Message Service (SMS) capability of the cellular telephony network. The embedded application transmits an information response 706 with the current location (latitude/longitude) of the mobile.

The invention has several advantages over existing methods. The method of augmentation based on establishing the location of a mobile subscriber's mobile subscriber terminal provides an additional layer of security. This additional layer of security is of special importance when the financial transaction occurs in a geographical location different from the mobile subscriber's home area. The mobile subscriber terminal is therefore likely to be in a roaming mode and this is addressed by the invention. A credit card transaction is rejected when it is ascertained that the mobile subscriber terminal associated with the purchaser is not in the vicinity of the POS terminal. This is of special importance when the credit-card user is traveling, for example, in a foreign country. Embodiments of the invention enable all credit card company fraud alert mechanisms to flag the usage of a credit card as being used in a geographical location distant from the mobile subscriber's home address. The premise of the augmentation method is that the presence of a mobile subscriber's mobile subscriber terminal close to a POS terminal will increase the probability that the card is being used by the authorized user.

The exchange of messages between the various entities can be achieved advantageously by packet communication using encrypted payloads over a conventional Internet Protocol (IP) network. Other methods for such communication include using high-speed voice-band modems over the public switched telephone network. Traditional POS terminals deployed currently communicate with the authorization entity using modems (dial-up).

The invention can be used to augment security in the case of secure log-in, especially when the subscriber is attempting to access financial institutions from a location, such as an Internet café, that is distinct and separate from his/her normal (e.g., home or office) location. Such situations arise naturally when the subscriber is traveling. The IP address of the log-in point will have an indication as to the location of the server being used and this can be compared with the location of the subscriber's mobile that is obtained in a manner taught by this invention. Numerous other applications requiring confirmation that are location-oriented can benefit from embodiments of the invention.

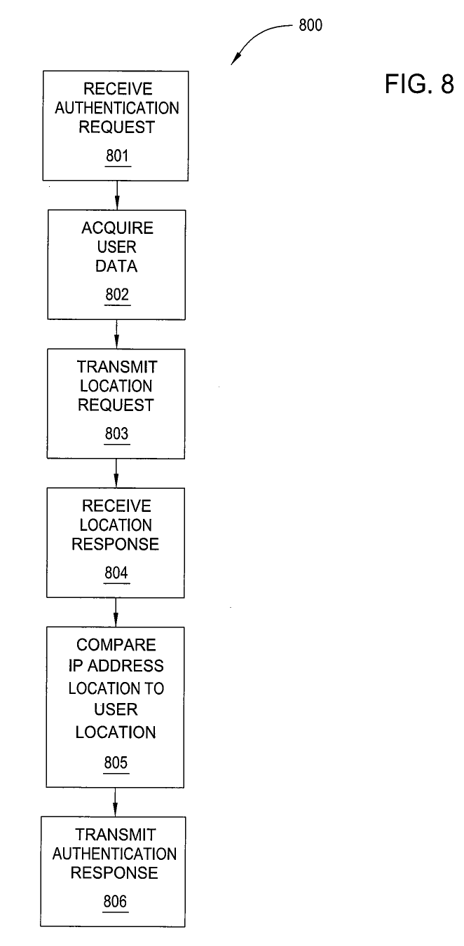

FIG. 8 is a flow chart that summarizes, in a stepwise fashion, a method 800 for authenticating a user for access to a secure account based on location information acquired by a location provider, according to an embodiment of the invention. By way of illustration, method 800 is described in terms of a transaction processing system substantially similar in organization and operation to transaction processing system 500 in FIG. 5, except that instead of a transaction that involves initiating a credit card transaction at POS 501, a user initiates a request to access a secure account via the Internet. Other transaction processing systems may also benefit from the use of method 800. Although the method steps are described in conjunction with FIG. 8, persons skilled in the art will understand that any system configured to perform the method steps falls within the scope of the present invention.

Prior to method 800, the user of mobile subscriber terminal 100 initiates a request to access a secure account via the Internet, such as a private bank account. In other embodiments, the account being accessed is not a financial account, but may be any account for which it is desirable for the user to be authenticated prior to having access to the account. When the user attempts to access the secure account, an authentication request is transmitted to an authentication entity, which determines whether the user may access the secure account. The authentication request includes an identification of the user, e.g. user ID, and the IP address from which the user is accessing the secure account.

The method begins in step 801, in which the authentication entity receives the authentication request. In step 802, the authentication entity acquires user data, such as the phone number of the user's mobile subscriber terminal. In step 803, the authentication entity transmits a location request to a location provider, such as location provider 106, 306, 506 described above. The location request includes the phone number of the user's mobile subscriber terminal. In step 804, the authentication entity receives a location response from the location provider. The location response includes location data indicating the current physical location of the user based on the location of the user's mobile subscriber terminal. The location of the user's mobile subscriber terminal is obtained by the location provider using the phone number of the user's mobile subscriber terminal in the same manner as described above for location providers 106, 306, 506.

In step 805, the authentication entity compares the physical location of the IP address associated with the user, as determined from methods known in the art, to the physical location of the user reported by the location provider in step 804 in order to authenticate the user. In step 806, the authentication entity either permits or denies access to the secure account based on the results of the comparison conducted in step 805. The authentication entity permits access if the two locations compared in step 805 are found to be within a predetermined minimum radius and denies access if the two locations compared in step 805 are found to be separated by more than the predetermined minimum radius. This predetermined minimum radius is set in the same manner described above in conjunction with FIG. 6.

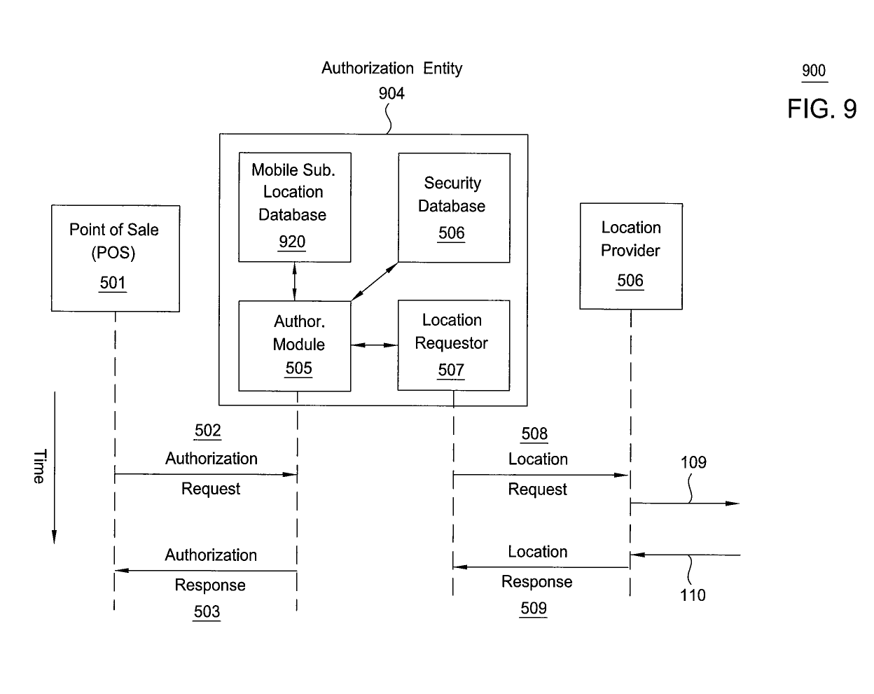

It is noted that location lookups for a roaming mobile subscriber, such as location request 508 made by authorization entity 504 in FIG. 5, can be time-consuming and, in terms of bandwidth and other resources, relatively expensive. Furthermore, location provider 506 may not always be available to send a location response 509 to an authorization entity 504 in answer to location request 508. Consequently, in some instances, an authorization request 502 cannot be completed in a timely manner when a transaction is initiated at POS 501. In such instances, when authorization entity 504 sends authorization response 503 to POS 501, authorization response 503 does not include the additional layer of security provided by confirming the location of the mobile subscriber. In some embodiments of the invention, this issue is addressed by storing location information for the mobile subscriber locally in a database that is associated with authorization entity 504. FIG. 9 illustrates one such embodiment.

FIG. 9 is a block diagram of a transaction processing system 900 illustrating the steps of a financial transaction that are carried out according to an embodiment of the present invention. The elements of transaction processing system 900 are substantially similar in organization and operation to transaction processing system 500 in FIG. 5, except that an authorization entity 904 also includes a mobile subscriber location database 920. Mobile subscriber location database 920 stores recent location lookups for mobile subscribers whose location has been recently determined via a location request 508 sent to location provider 506 by authorization entity 904. Location request 508 may be executed by authorization entity 904 in response to any triggering event, such as when a roaming mobile subscriber initiates a credit card transaction, as described above in method 600, or seeks access to a secure account, as described above in method 800.

According to some embodiments of the invention, whenever authorization entity 904 sends location request 508 in response to such a triggering event, the location information received by authorization entity 904 in location response 509 is time-stamped and stored in mobile subscriber location database 920. As described above in conjunction with FIGS. 6 and 8, authorization module 505 may use said location information to confirm that the mobile subscriber is located within a predetermined minimum radius of POS 501, thereby providing an additional layer of security to communications or transactions associated with the triggering event. In instances in which location response 509 is not received by authorization entity 904 in a timely fashion, e.g., quickly enough for the completion of a credit card transaction or for access to be granted to the mobile subscriber to a secure account, authorization entity 904 can either authorize the authorization request associated with the triggering event in a conventional manner, or deny the authorization request, depending on the configuration of authorization entity 904. In either case, the mobile subscriber location information that is ultimately received by authorization entity 904 in location response 509 is stored in mobile subscriber location database 920 for use in subsequent authorization requests 502.

Thus, when authorization entity 904 receives an authorization request, either from POS 501 or in response to some other a triggering event, authorization entity 904 can provide authorization request 503 without the added delay and cost of sending location request 508 to location provider 506 and waiting for location response 509. Instead, authorization entity 904 can compare the location of the triggering event with the mobile subscriber location information stored in mobile subscriber location database 920. Mobile subscriber location database 920 is generally positioned proximate authorization module 505, thereby facilitating speedy resolution of authorization request 503.

In some embodiments, mobile subscriber location information is time stamped when stored in mobile subscriber location database 920, and is considered invalid after a predetermined time period. In such embodiments, old, and most likely inaccurate, mobile subscriber location information is removed from mobile subscriber location database 920.

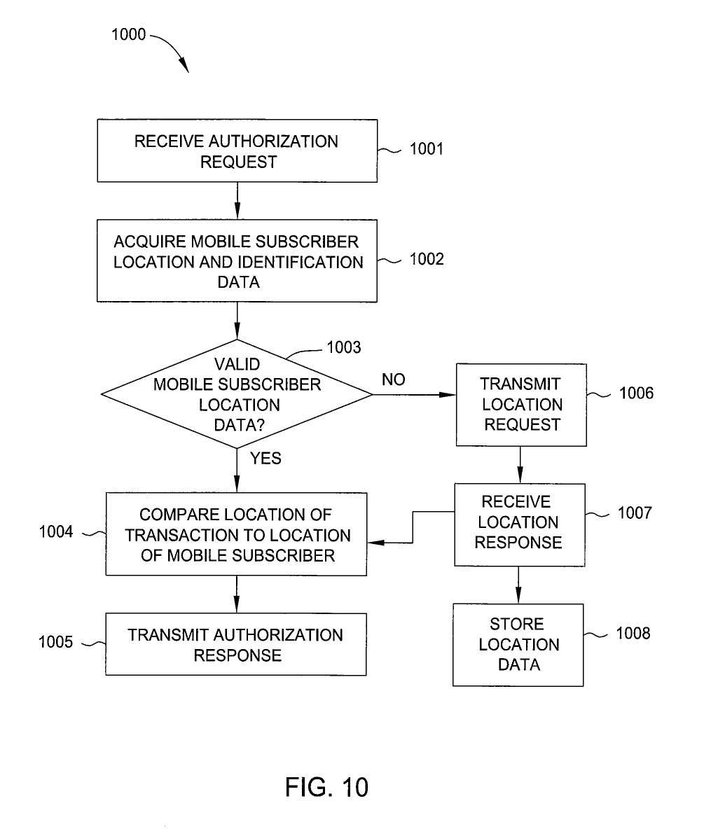

FIG. 10 is a flow chart that summarizes, in a stepwise fashion, a method 1000 for storing and using location information for a mobile subscriber in a database that is associated with an authorization entity, according to an embodiment of the invention. By way of illustration, method 1000 is described in terms of a transaction processing system substantially similar in organization and operation to transaction processing system 900 in FIG. 9. However, other transaction processing systems may also benefit from the use of method 1000. Thus, although the method steps are described in conjunction with FIG. 9, persons skilled in the art will understand that any system configured to perform the method steps falls within the scope of the present invention.

Prior to method 1000, the roaming user of mobile subscriber terminal 100 initiates a triggering event, such as a credit card purchase at POS 501, or submission of a request to access a secure account via the Internet or other network. In one embodiment, POS 501 queries authorization entity 904 by transmitting authorization request 502 to authorization entity 904 to confirm allowance of the transaction. Authorization request 502, which is described above in conjunction with FIG. 5 and method 600, includes an identification of the subscriber and the physical location of POS 501. In one embodiment, the request includes a time-stamp of authorization request 502.

Method 1000 begins in step 1001, in which authorization entity 904 receives authorization request 502. As noted above, authorization request 502 includes the physical location of the transaction taking place. In the case of an on-line transaction, the physical location for the transaction corresponds to a physical location of the IP address associated with the purchaser.

In step 1002, authorization entity 904 acquires mobile subscriber data from authorization request 502, such as mobile subscriber identification data and physical location data for the transaction.

In step 1003, authorization entity 904 searches mobile subscriber location database 920 for valid location information for the mobile subscriber terminal 100. When valid location information is available in subscriber location database 920, method 1000 proceeds to step 1004. When no valid location information is available, method 1000 proceeds to step 1006. Validity of location information is a function of how long the location information for a particular mobile subscriber terminal has been stored in mobile subscriber location database 920. Location information that has been stored in mobile subscriber location database 920 longer than a predetermined time period is considered invalid.

In step 1004, authorization entity 904 compares the physical location of the transaction as acquired in step 1002 to the physical location of the purchaser. The physical location of the purchaser is based on location information that has been either retrieved from mobile subscriber location database 920 in step 1003, or received in location response 509 from location provider 506 in step 1007 (described below).

In step 1005, authorization entity 904 transmits an appropriate authorization response 503 to POS 501 based on the results of step 1004. Various embodiments of authorization response 503 are described above in conjunction with step 606 of method 600. It is noted that, in some instances, authorization entity 904 may not transmit authorization response 503 in a timely manner. Specifically, when no valid location information is available for mobile subscriber terminal 100 in mobile subscriber location database 920 in step 1003, said location information is instead obtained via location response 509 from location provider 506, as described below in steps 1006 and 1007. The time elapsed before receiving location response 509 may exceed an allotted time frame for the authorization of the triggering event. Consequently, in such instances, no location validation is included in authorization response 503 in response to the triggering event. In some embodiments, the transaction or request associated with the triggering event receives authorization in a conventional manner. In other embodiments, in which the added security layer of location confirmation is required, said transaction or request is denied.

In step 1006, which takes place after step 1003 when no valid location information is available in mobile subscriber location database 920, authorization entity 904 transmits location request 508 to location provider 506.

In step 1007, authorization entity 904 receives location response 509 from location provider 506. Location response 509 includes location data indicating the current physical location of the purchaser based on the location of mobile subscriber terminal 100. Location response 509 is generated by location provider 506 as detailed above in conjunction with FIG. 5.

In step 1008, authorization entity 904 stores location data for mobile subscriber terminal 100 in mobile subscriber location database 920. In some embodiments, step 1008 is performed concurrently with step 1004. In some embodiments, authorization entity 904 also timestamps the location data for subsequently determining the validity of the location data. The stored location data can then be used for subsequent triggering events associated with the user of mobile subscriber terminal 100. Thus, when the user of mobile subscriber terminal 100 is roaming in a foreign country, where location look-ups are time-consuming and expensive, method 1000 can significantly reduce the number of such location look-ups performed by authorization entity 904. In addition, the use of method 1000 can eliminate the need for the user of mobile subscriber terminal 100 to contact his or her financial institution(s) before foreign travel.

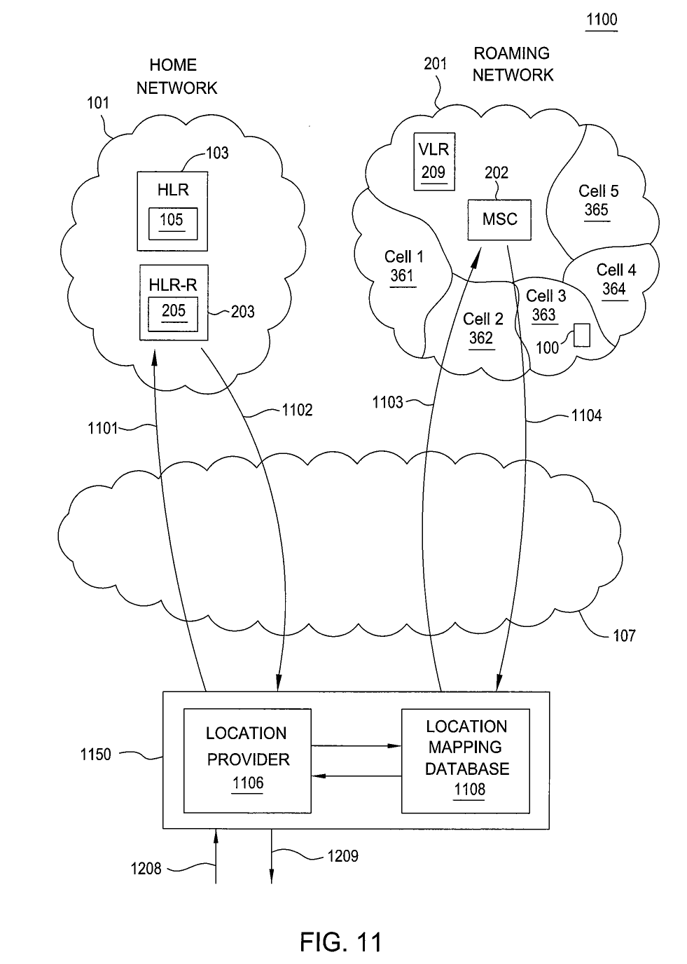

According to some embodiments of the invention, a system determines the location of a mobile subscriber terminal roaming outside a home network in a two-step process: (1) the system requests from the home network the roaming network MSCID that is currently serving the mobile subscriber terminal, and (2) the system procures from the roaming network the particular cell ID serving the mobile subscriber terminal and/or other location information from the roaming network. Thus, by providing the system with a unique mobile subscriber identifier, such as the MSISDN, the system can output a current location for the roaming mobile subscriber terminal with location resolution down to the cell in which the mobile subscriber terminal is located. Furthermore, when the unique mobile subscriber identifier is associated with a specific credit card account, the system can facilitate the use of location confirmation as an additional layer of security in credit card and other secure transactions. FIG. 11 illustrates one embodiment of such a system.

FIG. 11 is a conceptual diagram illustrating a system 1150 that outputs the current location of roaming mobile subscriber terminal 100 when system 1150 is queried with a unique mobile subscriber identifier, according to embodiments of the invention. As shown, system 1150 is connected to home network 101 and roaming network 201 of mobile subscriber terminal 100 via communication network 107. Home network 101, roaming network 201, and communication network 107 are each described previously. As noted above, communication network 107 may comprise the Internet, the SS7 network, the PSTN, or a combination thereof. In the embodiment illustrated in FIG. 11, system 1150 includes a location provider 1106 and a location mapping database 1108. Location provider 1106 may function similar to location provider 306 in FIG. 3 or location provider 506 in FIG. 5, and location mapping database 1108 may be substantially similar in organization and operation to location mapping database 308 in FIG. 3.

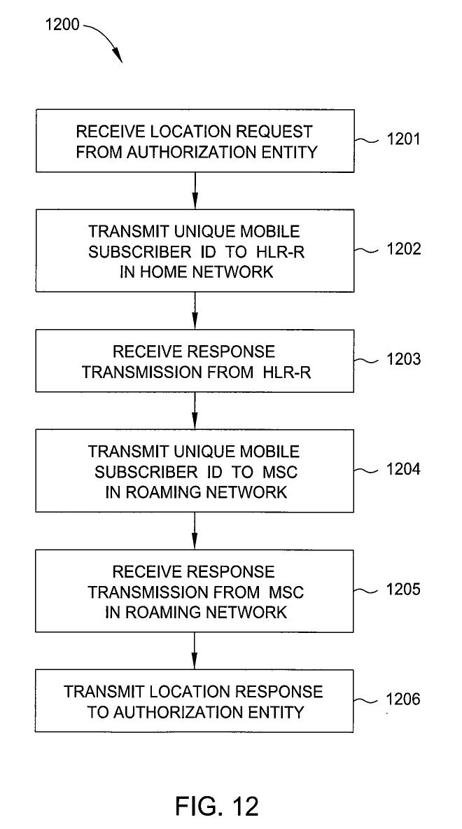

FIG. 12 is a flow chart that summarizes, in a stepwise fashion, a method 1200 for determining the location of a mobile subscriber terminal, according to an embodiment of the invention. By way of illustration, method 1200 is described in terms of a transaction processing system substantially similar in organization and operation to system 1150 in FIG. 11. However, other systems may also benefit from the use of method 1200. Thus, although the method steps are described in conjunction with FIG. 11, persons skilled in the art will understand that any system configured to perform the method steps falls within the scope of the present invention.

Prior to method 1200, a triggering event takes place that is associated with an activity benefiting from location confirmation for an added layer of security. As in other embodiments described above, the triggering event may be initiated by the user of mobile subscriber terminal 100 by attempting a credit card purchase or by submitting a request to access a secure account via the Internet or other network. In order to confirm the current location of the user of mobile subscriber terminal 100, an authorization entity substantially similar to authorization entity 504 in FIG. 5 transmits a location request 1208 to system 1150. Location request 1208 may be configured similar to location request 508 in FIG. 5, and includes a unique mobile subscriber identifier, such as the MSISDN, the mobile subscriber name and/or phone number, etc.

In step 1201, system 1150 receives location request 1208 from an appropriate authorization entity.

In step 1202, system 1150 transmits the unique mobile subscriber identifier in location request 1208 to HLR-R 203 in home network 101, via request transmission 1101. HLR-R 203 is described above on conjunction with FIG. 2. In some embodiments, request transmission 1101 is carried out using the Mobile Application Part (MAP) of the SS7 protocol, with short message protocol elements being transported across the network as fields within the MAP messages. In one such embodiment, request transmission 1101 provides the MSISDN of the user of mobile subscriber terminal 100 to HLR-R 203 in a Send Reply Information For Short Message (SRI-for-SM) format. Using the unique mobile subscriber identifier in location request 1208, HLR-R 203 can determine the MSCID of the MSC currently serving roaming mobile subscriber terminal 100 and provide said MSCID to system 1150 in response transmission 1102. In some embodiments, response transmission 1102 provides this MSCID to system 1150 in an SRI-for-SM format. In some embodiments, response transmission 1102 includes the International Mobile Subscriber Identity (IMSI) associated with mobile subscriber terminal 100. The IMSI of a mobile subscriber terminal is a unique identification associated with all GSM and UMTS network mobile phone users, and is typically stored as a 64-bit field in the SIM inside mobile subscriber terminal 100.

In step 1203, system 1150 receives response transmission 1102 from HLR-R 203. System 1150 now knows the MSCID of the MSC currently serving roaming mobile subscriber terminal 100 and, in some embodiments, the IMSI of mobile subscriber terminal 100. It is noted that, because an MSC can serve a relatively large geographical area, more location granularity is generally desired to facilitate location confirmation as an added layer of security. To that end, in steps 1204 and 1205, system 1150 acquires more precise location information for mobile subscriber terminal 100 from roaming network 201.

In step 1204, based on the MSCID received in step 1203, system 1150 transmits a unique mobile subscriber identifier to the appropriate MSC in roaming network 201, i.e., MSC 202. The unique mobile subscriber identifier is transmitted to MSC 202 via request transmission 1103. In some embodiments, request transmission 1103 comprises a packet system information (PSI) MAP message, which is sent to a Visitor Location Registry (VLR) 209 for MSC 202. VLR 209 includes a database of subscribers who have roamed into roaming network 201. In some embodiments, the unique mobile subscriber identifier transmitted to VLR 209 includes the IMSI associated with mobile subscriber terminal 100, which is received by system 1150 in step 1203.

In step 1205, system 1150 receives response transmission 1104 from VLR 209. In some embodiments, response transmission 1104 includes explicit location information, such as latitude/longitude coordinates, place names, and the like. In other embodiments, response transmission 1104 includes the cell ID of the cell in which mobile subscriber terminal 100 is located. It is noted that cell ID and location area code can be provided directly by VLR 209, while other location information that may be provided in response transmission 1104 typically requires additional communications. For example, to provide response transmission 1104 with latitude/longitude coordinates, a separate database generally associated with MSC 202 is consulted that includes physical locations of each cell therein. Consequently, when response transmission 1104 only provides information directly accessible to VLR 209, such as cell ID and/or location area code, response transmission 1104 can be sent to system 1150 in a more timely manner.

In step 1206, system 1150 transmits location response 1209 to the authorization entity that originated location request 1208. In some embodiments, location response 1209 includes the cell ID for the cell of MSC 202 in which mobile subscriber terminal 100 is located. In such embodiments, the authorization entity that transmitted location request 1208 to system 1150 may determine the location of mobile subscriber terminal 100 via a location mapping database similar to location mapping database 308 in FIG. 3. In other embodiments, location response 1209 includes explicit location information, such as latitude/longitude coordinates, place names, and the like. In such embodiments, system 1150 obtains such location information from a location mapping database 1158 in the same way that system 350 in FIG. 3 obtains geographical location for mobile subscriber terminal 100 from location mapping database 308. System 1150 can then include the location information so determined in location response 1209.

In sum, one or more embodiments of the invention provide techniques for locating a mobile subscriber roaming outside a home network. By providing a unique mobile subscriber identifier, such as the MSISDN, a current location for the roaming mobile subscriber terminal is output with location resolution down to the specific cell in which the mobile subscriber terminal is located. In some embodiments, the location of the mobile subscriber terminal is saved locally in a database associated with an authorization entity, thereby advantageously reducing the number of location look-ups requested by the authorization entity.

While the foregoing is directed to embodiments of the present invention, other and further embodiments of the invention may be devised without departing from the basic scope thereof, and the scope thereof is determined by the claims that follow.

I claim:

1. A method of authorizing a transaction, said method comprising the steps of:
receiving a request to authorize a transaction being conducted at a point-of-sale (POS);
acquiring purchaser data from the request;
transmitting a request to locate the purchaser and receiving location data indicating a location of the purchaser in response thereto;
storing the purchaser location;
comparing a POS location with the purchaser location; and
authorizing or denying the transaction based on the step of comparing.

2. The method of claim 1, wherein the POS location is determined from one of several locations associated with the POS merchant.

3. The method of claim 1, further comprising:
receiving a request to authorize a transaction being conducted at another point-of-sale (POS); and
authorizing or denying the transaction being conducted at said another POS based on a comparison of a location of said another POS with the stored purchaser location.

4. The method of claim 3, wherein the stored purchaser location is determined to be valid for said authorizing or denying the transaction being conducted at said another POS based on a lapsed time between the transactions.

5. The method of claim 3, wherein the stored purchaser location is determined to be valid for said authorizing or denying the transaction being conducted at said another POS based on a time stamp of the stored purchaser location and a time of the transaction being conducted at said another POS.

6. A method of authenticating a user for access to a secure account, comprising the steps of:
receiving a request to access the secure account from an IP address associated with the user;
transmitting a request to locate the user and receiving location data indicating a location of the user in response thereto;
storing the user location;
comparing a location associated with the IP address with the location of the user; and
authorizing or denying the access based on the step of comparing.

7. The method of claim 6, further comprising:
receiving a request to access the secure account from another IP address associated with the user; and
authorizing or denying the access to the secure account from said another IP address based on a comparison of a location of said another IP address with the stored user location.

8. The method of claim 7, wherein the stored user location is determined to be valid for said authorizing or denying the access to the secure account from said another IP address based on a lapsed time between the accesses.

9. The method of claim 7, wherein the stored user location is determined to be valid for said authorizing or denying the access to the secure account from said another IP address based on a time stamp of the stored user location and a time of the secure account from said another IP address.
